(19) United States
(12) Patent Application Publication
(10) Pub. No.: US 2018/0197227 A1
(43) Pub. Date: Jul. 12, 2018

(54) SYSTEM AND METHOD FOR DELIVERY OF RETAIL PRODUCTS

(71) Applicant: Wal-Mart Stores, Inc., Bentonville, AR (US)

(72) Inventors: Brian G. McHale, Chadderton Oldham (GB); Todd D. Mattingly, Bentonville, AR (US)

(21) Appl. No.: 15/862,223

(22) Filed: Jan. 4, 2018

Related U.S. Application Data
(60) Provisional application No. 62/443,147, filed on Jan. 6, 2017.

(51) Int. Cl. G06Q 30/06; H04W 4/029; H04W 4/80

(52) U.S. Cl. CPC G06Q 30/0631; G06Q 30/0641; G06Q 30/0639; H04W 4/80; H04W 4/029

(57) ABSTRACT

In some embodiments, systems, apparatuses and methods are provided herein useful to deliver retail products outside of a retail facility including: one or more sensors configured to monitor personal items associated with at least one of a user or a personal status of the user; a shopping user interface configured to operate on an electronic user device associated with the user; and a control circuit configured to: monitor individual activity associated with the user; estimate a travel location of the user; present a suggested retail item to the user based, in part, on readings from the one or more sensors monitoring the personal items associated with the at least one of the user or the personal status of the user; receive a request for the suggested retail item; and instruct delivery of the suggested retail item to the user at the travel location.

### CROSS-REFERENCE TO RELATED APPLICATION

This application claims the benefit of U.S. Provisional Application No. 62/443,147, filed Jan. 6, 2017, which is incorporated herein by reference in its entirety.

### TECHNICAL FIELD

This invention relates generally to delivering retail products outside of a retail facility.

### BACKGROUND

Retail stores aim to conveniently provide products and services to customers. To that end, retail stores are typically situated in high traffic areas or retail stores offer delivery to a customer. Nonetheless, there remains an interest in providing products to customers more readily, especially when customers are traveling. For example, a planned hike through the Grand Canyon might be in jeopardy if a customer has forgotten bug repellent or, worse yet, forgotten a water container or run out of water or any other item necessary to safely complete the hike. Unfortunately for traveling customers, in many remote, exotic, or difficult to reach destinations, there may not be a retail store readily or easily accessible. In another scenario, frequently used products, such as tissues, baby wipes or diapers, may become depleted during a family road trip at an inconvenient time. So, it would be desirable to have a delivery system that anticipates possible needs of these customers and/or make a delivery of the needed items based on the current location of the customer.

### BRIEF DESCRIPTION OF THE DRAWINGS

Disclosed herein are embodiments of systems, apparatuses and methods pertaining to delivering retail products outside of a retail facility. This description includes drawings, wherein:

FIG. 1 is an exemplary block diagram of a system for delivering retail products outside of a retail facility in accordance with some embodiments;

FIG. 2 is an exemplary flow diagram of a method for delivering retail products outside of a retail facility in accordance with some embodiments;

FIG. 3 is an exemplary flow diagram of a method for delivering retail products outside of a retail facility in accordance with some embodiments;

FIG. 4 is an exemplary flow diagram of a method for delivering retail products outside of a retail facility in accordance with some embodiments; and

FIG. 5 illustrates an exemplary system for use in implementing systems, apparatuses, devices, methods, techniques, and the like in delivering retail products outside of a retail facility in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for providing retail products to customers outside of a retail facility. In some embodiments, there is provided a system including one or more sensors configured to monitor personal items associated with at least one of a user or a personal status of the user, a shopping user interface configured to operate on an electronic user device associated with the user, and a control circuit in communication with the one or more sensors and the electronic user device. In one embodiment, the control circuit, along with the sensors, monitors individual activity associated with the user. The individual activity may include a present location of the user via at least one of the electronic user devices or the one or more sensors. By one approach, a travel location of the user is estimated by the control circuit. By another approach, the control circuit presents a suggested retail item to the user via the shopping user interface, based, in part, on readings from the one or more sensors monitoring the personal items associated with the at least one of the user or the personal status of the user. By another approach, the control circuit may receive a request for the suggested retail item and instruct delivery of the suggested retail item to the user at the travel location. Accordingly, the suggested retail items may be delivered to the user at the travel location based on locational data provided by the electronic user device.

In some configurations, the control circuit estimates a travel location arrival time associated with the travel location and instructs delivery of the suggested retail item at or after the estimated travel location arrival time. By some approaches, the control circuit receives a user travel itinerary with at least one user destination and analyzes the user travel itinerary when estimating the travel location of the user and the estimated travel location arrival time. Further, the control circuit may receive social media information, weather reports, and news reports for at least one of the travel location or the user destination and present the suggested retail item based, in part, on information therein.

To facilitate the provision supplies, the control circuit may monitor a plurality of users and individual activities or personal statuses associated with the plurality of users thereby permitting the control circuit to forecast retail needs of a specific population. In this manner, the control circuit may make adjustments to the supply chain or request additional supplies from suppliers or distribution centers. To that end, the control circuit may be configured to communicate the forecast retail needs of the specific population to a supply chain management server. As noted below, the control circuit may receive information from the customer users, such as travel plans, calendar/schedule information, mapping or location services, which can be consolidated with or analyzed together with other customer information to forecast needs and manage potential supply chain issues in advance. For example, if the control circuit understand that several thousand people are headed to a particular outdoor event and that the weather is scheduled to be inclement at that time, the control circuit may notify suppliers or distributers regarding a likely increase need in certain outdoor products such as, for example, ponchos, umbrellas, or rain boots, among others.

In operation, the sensors typically monitor a personal location of the user and are mounted on or in, for example, a vehicle, a trailer, a suitcase, a handbag, a trunk, a case, a personal effect, or a backpack of the user. By one approach, the sensors may include an optical sensor, a temperature sensor, a motion sensor, an accelerometer, a gyroscope, a digital camera, a solid state compass, an RFID tag and RFID reader, a force sensor, a global positioning system sensor, a fitness tracker, and/or a health or physical indicator. As used herein the health or physical indicator includes a heart rate sensor, a continuous glucometer, a blood pressure sensor, and/or a pulse oximeter, among other devices. In yet another configuration, the sensors include an optical sensor configured to monitor an inventory of retail items at a personal location. To that end, the optical sensor is configured to scan product codes on the retail items at the personal location. The optical sensor also may capture electronic images of the personal location such that the control circuit may analyze the captured electronic image to determine the retail items in the personal location. Furthermore, the control circuit may process the captured electronic images via at least one of image contrast enhancement or dynamic range reduction.

While the consolidated information or aggregated data permits the control circuit to manage the supply chain, additional information from the customer user, such as via a fitness or health tracker worn by the user may assist the control circuit in providing personalized suggestions to the customer user. For example, the control circuit (along with the associated databases) knows that I do not have certain provisions in my car, but knows that I will be hungry (or have low blood sugar) at a certain time when I am scheduled to be driving, the control circuit may consider presenting suggestions regarding, for example, food, snacks, beverages, and/or water, among other supplies. Further, the control circuit with the information obtained about the customer user may provide the goods (or even services) to a particular travel location where the customer user is expected to be at a particular time.

In some embodiments, there is provided a computer-implemented method for providing delivery of retail products outside of a retail facility including monitoring personal items associated with a user via at least one sensor mounted in a personal location, receiving a user travel itinerary with at least one user destination via a shopping user interface configured to operate on an electronic user device associated with the use, and monitoring an individual's activity including a present user location via the electronic user device associated with the user. By one approach, the method includes estimating a travel location of the user and an estimated arrival time associated with the travel location based, in part, on the travel itinerary and the present user location. By another approach, the methods include presenting a suggested retail item to the user, via the shopping user interface, based, in part, on readings from the at least one sensor mounted in the personal location, the at least one user destination, or the travel location, receiving a request for the suggested retail item, and instructing delivery of the suggested retail item to the user at the travel location.

In some embodiments, there is provided a retail store delivery system that tracks customers' travel plans and arranges delivery of one or more products based on their expected locations. Customers can associate travel with their customer profiles in the customer database, as described below. This may be done through a retail store application that allows the customer to physically input information and/or link to one or more internet travel sites (e.g., airlines, hotels, third party reservation services, among other things). Using the travel information, the system can identify products that a customer may be interested in purchasing based on a location where the customer is traveling to, duration of travel, types of activities expected to be done (e.g., identify that the customer is with her family and in an area that they are likely going to be visiting a beach), and the like. Further, the system can take advantage of a customer profile associated with the customer and identify brands of products the customer is more likely to prefer, which may be based on past purchases, preferences, value vectors, and the like. The system can further identify locations, away from the customer's home (or other locations where the customer typically receives deliveries) and can suggest delivery locations and/or times based on the customer's travel schedule. The system may further recommend to the customer and/or arrange for deliveries at the customer's home based on the customer's absence, such as the delivery of pet food.

By one approach, the system includes an item database that may be in communication with the control circuit and/or the sensors. The database may have a list or inventory of personal items, such as consumer products, associated with a user that can be updated based on information from the sensors. In this manner, the control circuit may keep track of the personal items under a user's control, such as, for example, in a user's vehicle or luggage, among other spaces or areas. For example, the item database may have information on the items in my suitcase, how full or empty my suitcase is, and/or how much it weighs, among other information. Accordingly, the control circuit may access the item database to determine what personal items the user has on-hand before presenting suggested retail items. In this manner, by one approach, the control circuit is presenting suggested retail items based on both the item database (determined based on the monitoring of personal items) and the customer's travel plans. The item database may be in addition to a customer user database that contains customer profiles with information about the customer such as their order history, preferences, payment information, and/or travel or calendar plans, among many other information. By one approach, the control circuit may access or otherwise consider the customer database when evaluating potential suggested retail items to present to the user.

In yet another aspect, the control circuit may deliver an item that a customer user is highly likely to need (for example if the control circuit would be strongly suggesting a retail item) without actually receiving a request or order from the customer user. In such a configuration, the customer user could reject the idea such as by returning the item or placing the item in a rejection bin at a retail facility, locker, or other public location such as post office or hotel. Based on whether the customer user accepts or rejects the retail item delivered without being ordered, the control circuit may update the customer database. This updated customer database may then be accessed when presenting suggested retail items as described herein.

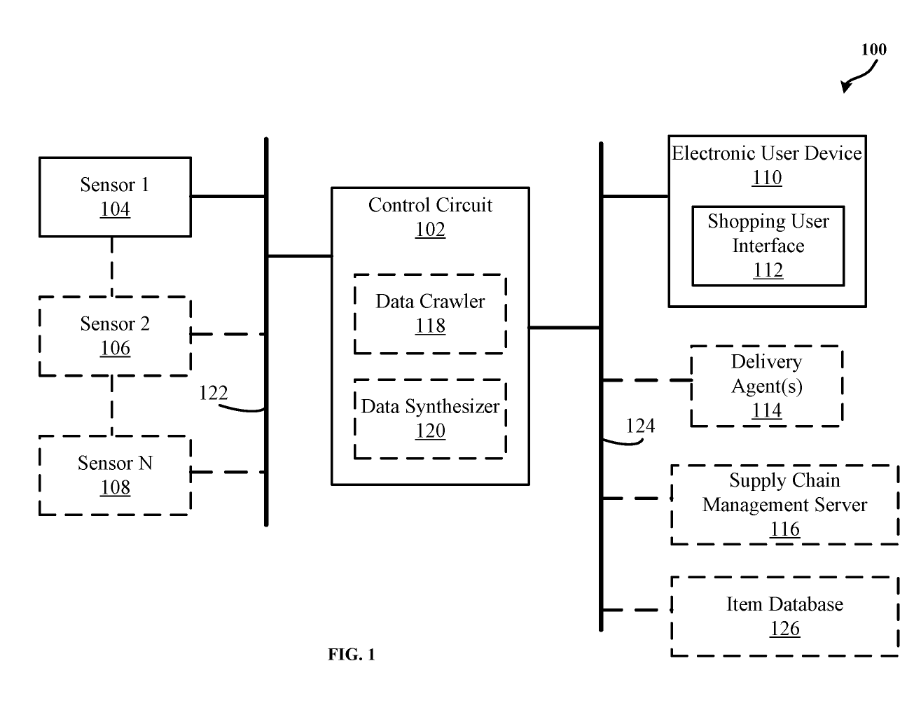

To illustrate, an exemplary block diagram of a travel shopping system 100 for delivering retail products outside of a retail facility is shown in FIG. 1. The system 100 includes one or more sensors 104, 106, 108 configured to monitor personal items associated with a user or a personal status of the user. By one approach, the sensors 104, 106, 108 may monitor a personal location of the user and are mounted on or in a vehicle, a trailer, a suitcase, a handbag, a trunk, a case, a personal effect, a backpack, and/or the user. The one or more sensors 104, 106, 108 may include an optical sensor, a temperature sensor, a motion sensor, an accelerometer, a gyroscope, a digital camera, a solid state compass, an RFID tag and RFID reader, a force sensor, a global positioning system (GPS) sensor, a fitness tracker, and/or a health or physical indicator, among other sensors capable of monitoring the customer's personal items or personal status. Further, the health or physical indicator may include a heart rate sensor, a continuous glucometer, a blood pressure sensor, and/or a pulse oximeter. Moreover, the optical sensor may be configured to monitor an inventory of retail items at the personal location or the items associated with the user (such as, for example, the user's luggage). The optical sensor may also scan product codes on the retail items at the personal location.

For example, the first sensor 104 may correspond to, for example, an optical sensor. The first sensor 104 may monitor a trunk of a vehicle used by the user by scanning the product codes of retail items in the trunk. In another example, the first sensor 104 may capture images of the retail items and send the images to a control circuit 102 for processing. By one approach, the third sensor 108 may correspond to, for example, the GPS sensor. The third sensor 108 may determine the user's current location and provide data associated with the user's current location to the control circuit 102.

By another approach, the system 100 may include a shopping user interface 112 configured to operate on an electronic user device 110 associated with the customer user. In one configuration, the electronic user device 110 may include the one or more sensors 104, 106, 108 incorporated therein and/or may be in communication therewith. For example, the electronic user device 110 may include the third sensor 108, for example, the GPS sensor. In another configuration, the shopping user interface 112 may include a software interface or an application executed in the electronic user device (APP). The electronic user device 110 may include a mobile phone, a smartphone, a tablet, a laptop, a computer, and/or any device capable of processing data and communicating with other devices.

Further, the shopping user interface 112 may be executed within or on the electronic user devices of the users, travelers, and/or customers. The shopping user interface 122 may be provided to the electronic user devices by the control circuit or may be configured to be executed by the electronic devices when in communication with the control circuit.

Moreover, the system 100 may include the control circuit 102 in communication with the one or more sensors 104, 106, 108 via a first network 122. The control circuit 102 may also be in communication with the electronic user device 110 via a second network 124. In one configuration, the first network 122 may be distinct from the second network 124. In another configuration, the first network 122 may correspond to the second network 124. Moreover, the control circuit 102 may monitor individual activity associated with the user including a present location of the user via at least one of the electronic user device 110 or the one or more sensors 104, 106, 108.

For example, if an electronic calendar of the electronic user device 110 indicates that on a particular day a user has a breakfast meeting with coworkers, the control circuit 102 may notify the user, via the electronic user device 110, regarding picking up certain supplies or provisions for the breakfast meeting based on previous purchases. In this manner, if the user typically brings certain food items and the sensors do not detect the presence of such items in the vehicle, the control circuit 102 may suggests such items be delivered to the user, possibly at the user's place of work. In this non-limiting, illustrative example, the control circuit 102 may have monitored that on the particular day, the user has the breakfast meeting and needed breakfast items for that meeting. In one configuration, a data crawler 118 may access the electronic user device 110 to acquire and/or analyze data associated with the user's calendar. The data synthesizer 120 may aggregate the data to associate events that the user may go through during the particular day. Thus, in this non-limiting, illustrative example, the data synthesizer 120 may have determined that the user has the breakfast meeting scheduled for the particular day based on calendar data located by the data crawler 118.

In another example, the data crawler 118 may have located other data that the data synthesizer 120 may use to determine the personal items associated with the user (may also be referred to as a customer user, customer, or an individual), a user travel itinerary, and/or the user's activity. For example, the user may have created a note in the electronic user device 110 indicating that a memo pad needs to be bought for the particular day. Thus, the control circuit 102 may send a second notification to the user via the electronic user device 110 that the memo pad is needed. In response, the control circuit 102 may also present a suggested memo pad via the shopping user interface 112 to the user.

By one approach, the control circuit 102 may estimate a destination, intermediary location, route, or travel location of the user. For example, the control circuit 102 may determine that the user may be at a predefined location based on the estimated travel location. The control circuit 102 may also estimate the travel location based on the control circuit 102 tracking the user's location via the electronic user device 110. In one configuration, the control circuit 102 may receive data corresponding to a unique identifier associated with the electronic user device 110. The unique identifier may include at least one of a GPS location or a media access control (MAC) address of the electronic user device 110.

By another approach, the control circuit 102 may present a suggested retail item to the user, via the shopping user interface 112, based, in part, on readings from the one or more sensors 104, 106, 108 monitoring the personal items associated with the at least one of the user or the personal status of the user. In a non-limiting, illustrative example, the first sensor 104 located in a trunk of a vehicle of the user may be configured to capture electronic images of the trunk (i.e., user's personal location). The electronic images may include, for example, a tent, a camping bag, and an iron skillet. In response, the first sensor 104 may provide the electronic images to the control circuit 102. The control circuit 102 may analyze the electronic images to determine retail items in the trunk. As such, the control circuit 102 may determine that the trunk includes the tent, the camping bag, and the iron skillet based on identifiers on the retail items. The identifiers may include RFID tags, UPC symbols, or any other type of identifiers associated with a particular item of a product. By one approach, the system 100 may include an item database 126 that may be updated with the information from the electronic images such that the item database 126 is updated to note that the trunk associated with a particular customer profile has a tent, camping bag, and an iron skillet therein. In this manner, if the weather indicates that rain is likely, the control circuit 102 may present or suggest an umbrella or poncho for purchase to the user via the shopping user interface 112.

In one configuration, the control circuit 102 may analyze the electronic images based, in part, on processing the electronic images via image contrast enhancement and/or dynamic range reduction. As such, the control circuit 102, via the data synthesizer 120 (and/or the data crawler 118), may determine that the user is going camping. The data synthesizer 120 may determine, for example, based on the electronic images and/or the processed electronic images, that one or more items associated with the camping trip are missing, such as, for example, a sleeping bag. Accordingly, the control circuit 102 may suggest the missing one or more items (e.g., the sleeping bag) to the user via the shopping user interface 112. In one configuration, the control circuit 102 may also determine that the user is going camping based on the second sensor 106, for example the GPS sensor, of the electronic user device 110. Moreover, the personal status of the user may be determined based on data gathered by the data crawler 118 from the electronic user device 110 and/or data available on the internet, where the internet available data are associated with the user. For example, the user's online account (such as, for example, a social media account) may indicate that the user is driving to a camp site. The user may also post photos on the online account, the photos are indicative of the user driving to the camp site.

In one illustrative embodiment, the control circuit 102 may receive a request for the suggested retail item and instruct delivery of the suggested retail item to the user at the travel location, such as along the route or at the destination. Continuing from the non-limiting, illustrative example above, in response to the presentation of the missing one or more item, for example, a portable gas powered stove top and a sleeping bag, the customer may send a request for the missing one or more item, upon selection of one of the presented suggested retail items. The control circuit 102 may receive the request and, in response to the request, instruct delivery of the missing one or more items (e.g., a gas powered stove top and a sleeping bag). A delivery location may be determined based on locational data received by the control circuit 102. The locational data may be associated with data from the second sensor 106 of the electronic user device 110 and/or the travel plans or itinerary of the customer user (which may be found in the customer database). The data may be provided by the electronic user device 110 to the control circuit 102. Thus, the delivery of the suggested retail item is not necessarily based on a particular address of a location but, may instead, be based on positional location of the user using a positional sensor that may be associated with the vehicle, the electronic user device 110, a navigational system, or any sensor that provides locational data and the known or estimated travel plans or route.

Moreover, the control circuit 102 may estimate a travel location arrival time associated with the travel location and instruct delivery of the suggested retail item at or after the estimated travel location arrival time. For example, the control circuit 102 may send a notification to a delivery agent 114 of the request for the suggested retail item. The delivery agent 114 may include one or more delivery people and/or one or more transport vehicles. The one or more transport vehicles may include manned and unmanned vehicles. By one approach, the one or more delivery agents may include delivery associates of a retail store, customers of the retail store, and/or individuals who chose to make deliveries for the retail store including crowd-sourced individuals. In one configuration, the control circuit 102 may estimate the travel location arrival time based on the location data of the second sensor 106 and itinerary or travel plans. The control circuit 102 may provide the estimated travel location arrival time to the delivery agent 114. The delivery agent 114 may deliver the suggested retail item to a storage locker or to the user. Upon delivery of the suggested retail item, the delivery agent 114 may send a message to the control circuit 102 that the delivery is complete. By another approach, the control circuit 102 may determine that the delivery is complete based on data received from the storage locker.

In another configuration, the control circuit 102 may receive a user travel itinerary with at least one user destination and analyze the user travel itinerary when estimating the travel location of the user and the estimated travel location arrival time. The user travel itinerary may be received by the control circuit 102 via the second network 124. The customer may provide the user travel itinerary via the shopping user interface 112. By one approach, the data synthesizer 120 may analyze the user travel itinerary in addition to the data received from the one or more sensors 104, 106, 108 when estimating the travel location of the user and the estimated travel location arrival time.

In another configuration, the control circuit 102 may receive social media information, weather reports, news reports, and other information for at least one of the travel location, route, or the user destination and present the suggested retail item based, in part, on information therein. The travel location may include a location along a travel route or a destination. By one approach, the control circuit 102 may monitor a plurality of users and individual activities or personal statuses associated with the plurality of users thereby permitting the control circuit to forecast retail needs of a specific population. The forecast retail needs of the specific population may be communicated by the control circuit 102 to a supply chain management server 116. The supply chain management server 116 may include inventory data of the possible suggested items to customers at various retail facilities such as a retail store or distribution center. By another approach, the control circuit 102 may monitor a plurality of users and individual activities or personal statuses associated with the plurality of users via the one or more sensors 104, 106, 108 associated with the plurality of users. In one scenario, the control circuit 102 may suggest a retail item to a particular customer based on data resulting from the monitoring of the plurality of users and individual activities or the personal statuses associated with the plurality of users. For example, the control circuit 102 may have monitored that the plurality of users in the camp site that the customer is heading to have been ordering ponchos. In response, the control circuit 102 may suggest a poncho to the customer via the shopping user interface 112. For example, the control circuit 102 may analyze the item database 126 or purchasing histories of customers in a certain area to determine that a vast majority of customer users have purchased or brought a particular item on a trip and the control circuit 102 may consider presenting such a particular item as a suggested item to those users who do not have that particular item in their inventories or the item database 126.

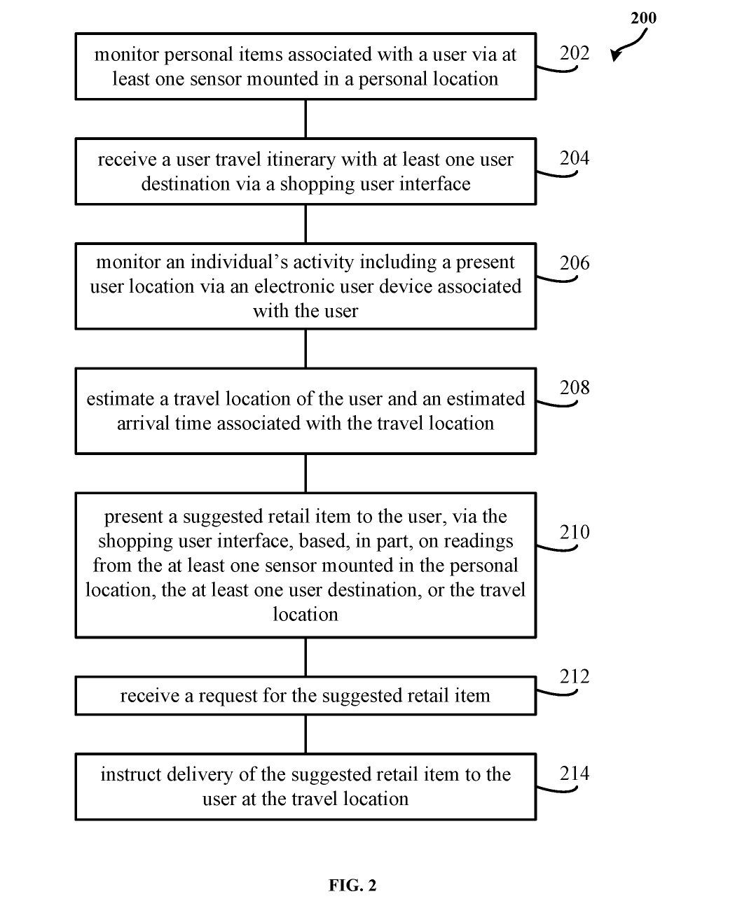

FIG. 2 illustrates a flow diagram of an exemplary method 200 for delivering retail products outside of a retail facility. The exemplary method 200 may be implemented in the system 100 of FIG. 1. The method 200 includes, at step 202, monitoring personal items associated with a user via at least one sensor mounted in a personal location. The at least one sensor may include, for example, the one or more sensors 104, 106, 108 of FIG. 1. The personal location may be associated with the user's person, a vehicle, a trailer, a suitcase, a handbag, a trunk, a case, a personal effect, and/or a backpack of the user, among other spaces, areas, or locations. At step 204, the method 200 may include receiving a user travel itinerary with at least one user destination via a shopping user interface configured to operate on an electronic user device associated with the user. The method also may include receiving routing plans or travel details via the shopping user interface. The shopping user interface may correspond to, for example, the shopping user interface 112 of FIG. 1, and the electronic user device may correspond to the electronic user device 110 of FIG. 1. An individual's activity including a present user location may be monitored via the electronic user device associated with the user, at step 206. At step 208, the method 200 may include estimating a travel location of the user and an estimated arrival time associated with the travel location based, in part, on the travel itinerary and the present user location. The method 200 may also include, at step 210, presenting a suggested retail item to the user, via the shopping user interface, based, in part, on readings from the sensor(s) mounted in the personal location, the at least one user destination, and/or the travel location. A request for the suggested retail item may also be received, at step 212. By one approach, the request for a suggested retail item may include submission of an item order such as by accepting a suggestion. The method 200 may include, at step 214, instructing delivery of the suggested retail item (such as by instructing packing and shipping of the retail item(s) ordered or requested) to the user at the travel location.

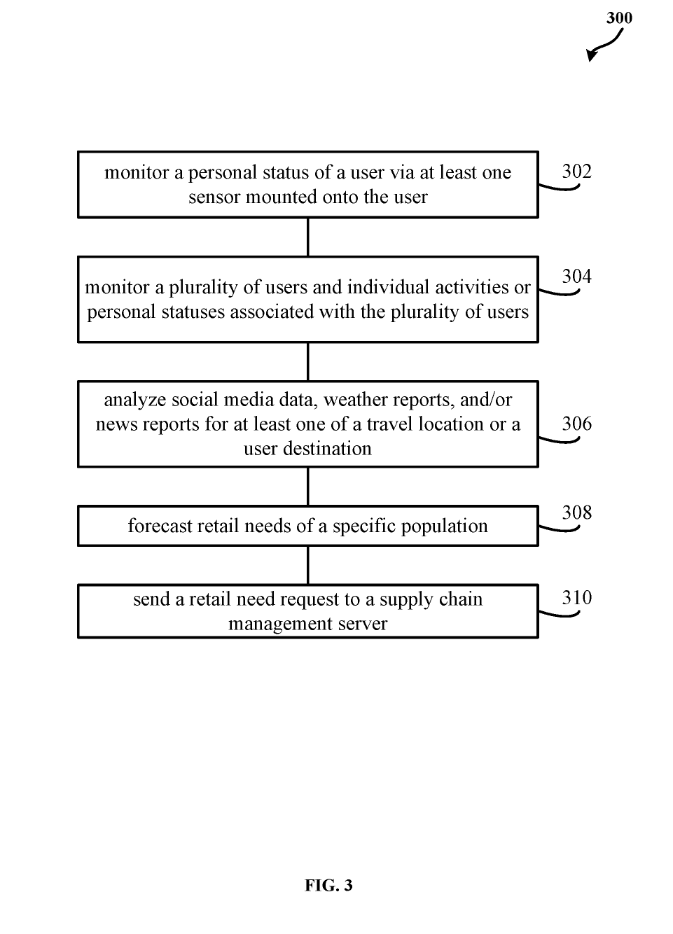

FIG. 3 illustrates a flow diagram of an exemplary method 300 for delivering retail products outside of a retail facility. By one approach, the exemplary method 300 may be implemented in the system 100 of FIG. 1. By another approach, the method 300 and/or one or more steps of the method 300 may optionally be included in and/or performed in cooperation with the method 200 of FIG. 2. The method 300 includes, at step 302, monitoring a personal status of a user via at least one sensor mounted onto the user. At step 304, the method 300 may include monitoring a plurality of users and individual activities or personal statuses associated with the plurality of users. The method 300 may also include, at step 306, analyzing social media data, weather reports, and/or news reports for at least one of the travel location, route, or the user destination. By one approach, the presenting of the suggested retail item is based, in part, on information therein. At step 308, the method 300 may include forecasting retail needs of a specific population (e.g., those users in a certain geographic area, of demographic, and/or with similar travel plans) based, in part, on the monitoring of the plurality of users and individual activities or personal statuses associated with the plurality of users. Based on this information, a retail request may be sent to a supply chain management server, at step 310. The supply chain management server may correspond, for example, to the supply chain management server 116 of FIG. 1.

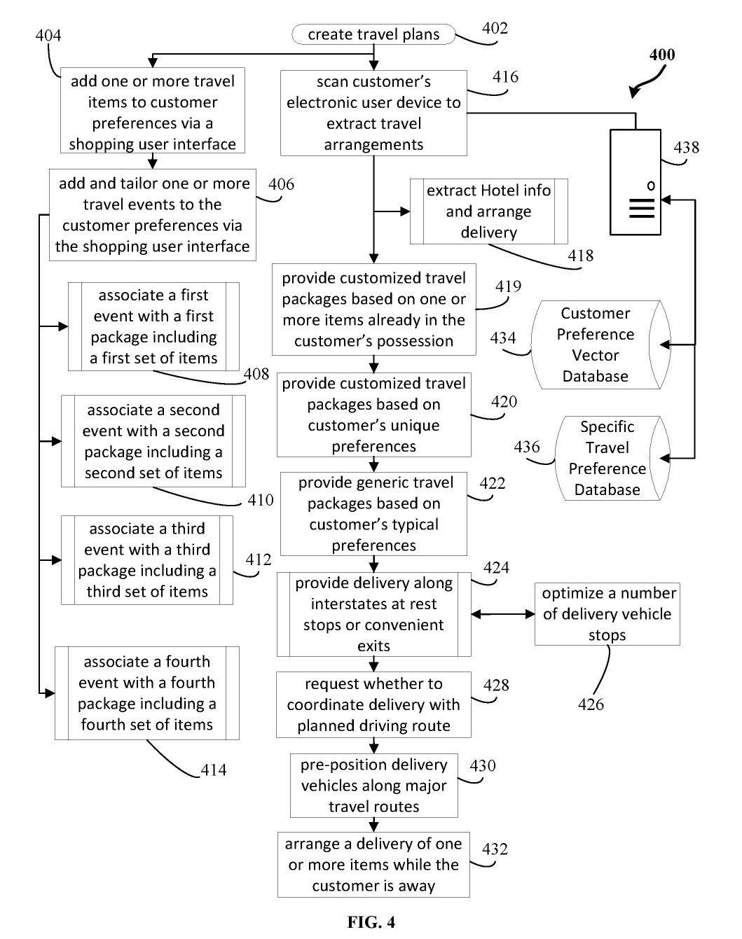

FIG. 4 illustrates a flow diagram of an exemplary method 400 for delivering retail products outside of a retail facility. By one approach, the exemplary method 400 may be implemented in the system 100 of FIG. 1. By another approach, the method 400 and/or one or more steps of the method 400 may optionally be included in and/or performed in cooperation with the method 200 of FIG. 2 and/or method 300 of FIG. 3. The method 400 includes, at step 402, creating travel plans. At step 404, the method may include adding travel items to the customer preferences via a shopping user interface. At step 406, the method may also include adding and tailoring one or more travel events to the customer preferences via the shopping user interface.

By one approach, the method 400 may include associating particular travel items with particular travel events. At step 408, the customer may associate a first event with a first package including a first set of items. For example, the customer may associate business events with a first package that includes a first set of items that may be needed during a business trip. The first set of items may include, for example, shoe polish, lint brush, tooth paste, and tooth brush, among other things. At step 410, the customer may associate a second event with a second package including a second set of items. For example, the customer may associate beach vacation events with a second package that includes a second set of items that may be needed during a beach vacation. The second set of items may include, for example, sunscreen, flip-flops, beach towels, and sunglasses, among other things. At step 412, the customer may associate a third event with a third package including a third set of items. For example, the customer may associate personal trip events with the third package that includes the third set of items that may be needed during a personal trip. The third set of items may include, for example, diapers, baby wipes, and baby care products, among other things. At step 414, the customer may associate a fourth event with a fourth package including a fourth set of items. For example, the customer may associate flight cancellation with the fourth package that includes the fourth set of items. The fourth set of items may include, for example, change of clothes, tooth brush, and tooth paste, among other things.

By one approach, at step 416, the method 400 may include scanning the electronic user device of the customer to extract travel arrangements. For example, the data crawler 118 may scan through the electronic user device to determine the travel arrangements of the customer. Such arrangements or information also may be forwarded or sent to a control circuit. Hotel information may be extracted from the travel arrangements found via scanning of the electronic user device and, in response, delivery arrangement may be arranged, at step 418. The delivery arrangements may be made with the delivery agent 114 of FIG. 1. At step 419, the method 400 may include providing customized travel packages based on one or more items already in the customer's possession. For example, the one or more sensors 104, 106, 108 of FIG. 1 may monitor the one or more items the customer may already have in possession, for example, such as items in customer's vehicle, pantry, house, bag, and/or shed, among other places. At step 420, the method 400 may include providing customized travel packages based on customer's unique preferences. At step 422, the method 400 may also include providing generic travel packages based on customer's typical preferences. The customer's unique preferences and the customer's typical preferences may be based on an associated profile in a customer preference vector database 434 and/or a specific travel preference database 436. In one scenario, a server 438 may include the customer preference vector database 434 and the specific travel preference database 436.

Moreover, the method 400 may, at step 424, provide delivery along interstates at rest stops and/or convenient exits. At step 426, the method 400 may include optimizing a number of delivery vehicle stop based on data generated by monitoring of a plurality of users, including the customer, and individual activities or personal statuses associated with the plurality of users by the control circuit. At step 428, the method 400 may include requesting whether to coordinate a delivery with a planned driving route if the customer is on a road trip. At step 430, the method 400 may include pre-positioning delivery vehicles along major travel routes based on the customer's retail order. By one approach, at step 432, the method 400 may include arranging the delivery of one or more items on the retail order to the customer's house while the customer is away. For example, the one or more items may include pet food.

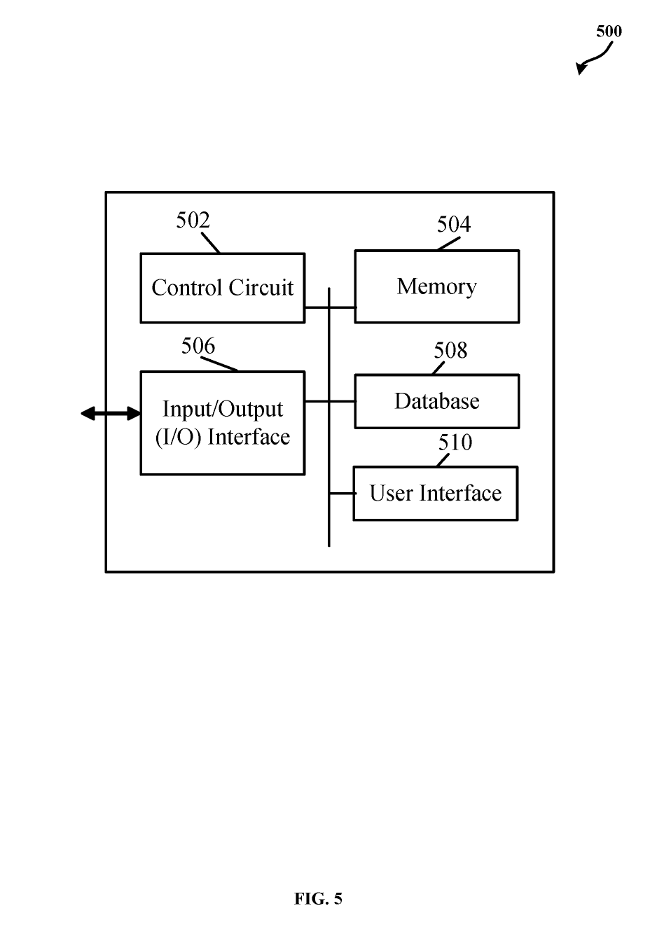

The methods, techniques, systems, devices, services, servers, sources and the like described herein may be utilized, implemented and/or run on many different types of devices and/or systems. Referring to FIG. 5, there is illustrated a system 500 that may be used for any such implementations, in accordance with some embodiments. One or more components of the system 500 may be used to implement any system, apparatus or device mentioned above, or parts of such systems, apparatuses or devices, such as for example any of the above or below mentioned control circuits, image capturing devices, servers, electronic user devices, databases, parts thereof, and the like. However, the use of the system 500 or any portion thereof is certainly not required.

By way of example, the system 500 may include one or more control circuits 502, memory 504, input/output (I/O) interface 506, database 508, and/or user interface 510. The control circuit 502 typically comprises one or more processors and/or microprocessors. The memory 504 stores the operational code or set of instructions that is executed by the control circuit 502 and/or processor to implement the functionality of the systems and devices described herein, parts thereof, and the like. In some embodiments, the memory 504 may also store some or all of particular data that may be needed to deliver retail products outside of a retail facility.

It is understood that the control circuit 502 and/or processor may be implemented as one or more processor devices as are well known in the art. Similarly, the memory 504 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 504 is shown as internal to the system 500; however, the memory 504 can be internal, external or a combination of internal and external memory. Similarly, the database 508 is shown as internal to the system 500; however, the database 508 can be internal, external or a combination of internal and external database. Additionally, the system typically includes a power supply (not shown), which may be rechargeable, and/or it may receive power from an external source. While FIG. 5 illustrates the various components being coupled together via a bus, it is understood that the various components may actually be coupled to the control circuit 502 and/or one or more other components directly.

Generally, the control circuit 502 and/or electronic components of the system 500 can comprise fixed-purpose hard-wired platforms or can comprise a partially or wholly programmable platform. These architectural options are well known and understood in the art and require no further description here. The system and/or control circuit 502 can be configured (for example, by using corresponding programming as will be well understood by those skilled in the art) to carry out one or more of the steps, actions, and/or functions described herein. In some implementations, the control circuit 502 and the memory 504 may be integrated together, such as in a microcontroller, application specification integrated circuit, field programmable gate array or other such device, or may be separate devices coupled together.

The I/O interface 506 allows wired and/or wireless communication coupling of the system 500 to external components and/or or systems. Typically, the I/O interface 506 provides wired and/or wireless communication (e.g., Wi-Fi, Bluetooth, cellular, RF, and/or other such wireless communication), and may include any known wired and/or wireless interfacing device, circuit and/or connecting device, such as but not limited to one or more transmitter, receiver, transceiver, etc.

The user interface 510 may be used for user input and/or output display. For example, the user interface 510 may include any known input devices, such one or more buttons, knobs, selectors, switches, keys, touch input surfaces, audio input, and/or displays, etc. Additionally, the user interface 510 include one or more output display devices, such as lights, visual indicators, display screens, etc. to convey information to a user, such as but not limited to communication information, suggested retail items, status information, order information, delivery information, notifications, errors, conditions, and/or other such information. Similarly, the user interface 510 in some embodiments may include audio systems that can receive audio commands or requests verbally issued by a user, and/or output audio content, alerts and the like.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A travel shopping system for delivery of retail products outside of a retail facility comprising:
one or more sensors configured to monitor personal items in a vehicle associated with at least one of a user or a personal status of the user; and provide sensor data to a control circuit, wherein the sensor data includes the monitored personal items;
a shopping user interface configured to operate on an electronic user device associated with the user; and
the control circuit in communication with the one or more sensors and the electronic user device, the control circuit configured to:
monitor individual activity associated with the user including a present location of the user based on at least one of: user data provided by the electronic user device or the sensor data provided by the one or more sensors;
estimate a travel location of the user based on at least one of the monitored personal items;
present a suggested retail item to the user, via the shopping user interface, based, in part, on the monitored personal items from the one or more sensors;
receive a request for the suggested retail item from the user through the shopping user interface; and
instruct delivery of the suggested retail item to the user at the travel location.

2. The travel shopping system of claim 1, wherein the control circuit is further configured to:
estimate a travel location arrival time associated with the travel location; and instruct delivery of the suggested retail item at or after the estimated travel location arrival time.

3. The travel shopping system of claim 2, wherein the control circuit is further configured to receive a user travel itinerary with at least one user destination and analyze the user travel itinerary when estimating the travel location of the user and the estimated travel location arrival time.

4. The travel shopping system of claim 3, wherein the control circuit is configured to receive social media information, weather reports, and news reports for at least one of the travel location or the at least one user destination and present the suggested retail item based, in part, on information therein.

5. The travel shopping system of claim 1, wherein the control circuit is further configured to monitor a plurality of users and individual activities or personal statuses associated with the plurality of users thereby permitting the control circuit to forecast retail needs of a specific population.

6. The travel shopping system of claim 5, wherein the control circuit is further configured to communicate the forecast retail needs of the specific population to a supply chain management server.

7. The travel shopping system of claim 1, wherein the one or more sensors monitor a personal location of the user and are mounted on or in at least one of: a vehicle, a trailer, a suitcase, a handbag, a trunk, a case, a personal effect, or a backpack of the user.

8. The travel shopping system of claim 1, wherein the one or more sensors comprises at least one of: an optical sensor, a temperature sensor, a motion sensor, an accelerometer, a gyroscope, a digital camera, a solid state compass, an RFID tag and RFID reader, a force sensor, a global positioning system sensor, a fitness tracker, and a health or physical indicator.

9. The travel shopping system of claim 8, wherein the health or physical indicator comprises at least one of: a heart rate sensor, a continuous glucometer, a blood pressure sensor, and a pulse oximeter.

10. The travel shopping system of claim 8, wherein the one or more sensors comprise at least one optical sensor configured to monitor an inventory of retail items at a personal location.

11. The travel shopping system of claim 10, wherein the at least one optical sensor scans product codes on the retail items at the personal location.

12. The travel shopping system of claim 10, wherein the at least one optical sensor is configured to capture electronic images of the personal location, and wherein the control circuit is further configured to analyze the captured electronic image to determine the retail items in the personal location.

13. The travel shopping system of claim 12, wherein the control circuit is further configured to process the captured electronic images via at least one of image contrast enhancement or dynamic range reduction.

14. The travel shopping system of claim 1, wherein the suggested retail item is delivered to the user at the travel location based on locational data provided by the electronic user device, and wherein the monitoring of the personal items in the vehicle is during a travel of the user to the travel location.

15. A computer-implemented method for providing delivery of retail products outside of a retail facility comprising:
monitoring personal items associated with a user via at least one sensor mounted in a personal location, wherein the personal location corresponds to an area in a vehicle associated with the user;
receiving a user travel itinerary with at least one user destination via a shopping user interface configured to operate on an electronic user device associated with the user;
monitoring an individual's activity including a present user location via the electronic user device associated with the user;
estimating a travel location of the user and an estimated arrival time associated with the travel location based, in part, on the user travel itinerary and the present user location;
presenting a suggested retail item to the user, via the shopping user interface, based, in part, on readings from the at least one sensor mounted in the personal location, the at least one user destination, or the travel location;
receiving a request for the suggested retail item; and
instructing delivery of the suggested retail item to the user at the travel location.

16. The method of claim 15, further comprising monitoring a personal status of a user via at least one sensor mounted onto the user.

17. The method of claim 16, further comprising monitoring a plurality of users and individual activities or personal statuses associated with the plurality of users.

18. The method of claim 17, further comprising: forecasting retail needs of a specific population based, in part, on the monitoring of the plurality of users and individual activities or personal statuses associated with the plurality of users; and sending a retail need request to a supply chain management server.

19. The method of claim 15, further comprising analyzing social media data, weather reports, and news reports for at least one of the travel location or the at least one user destination, wherein the presenting of the suggested retail item is based, in part, on information therein.

20. The method of claim 15, wherein the suggested retail item is delivered to the user at the travel location based on locational data provided by the electronic user device, and wherein the monitoring of the personal items in the vehicle is during a travel of the user to the travel location.
